(19) United States
(12) Patent Application Publication
(10) Pub. No.: US 2024/0002151 A1
(43) Pub. Date: Jan. 4, 2024

(54) A STORAGE CONTAINER HANDLING SYSTEM AND A METHOD OF TRANSFERRING A STORAGE CONTAINER

(71) Applicant: Autostore Technology AS, Nedre Vats (NO)

(72) Inventors: Jørgen Djuve Heggebø, Olen (NO); Trond Austrhelim, Etne (NO)

(73) Assignee: Autostore Technology AS, Nedre Vats (NO)

(21) Appl. No.: 18/253,522

(22) PCT Filed: Jan. 17, 2022
(86) PCT No.: PCT/EP2022/050905

§ 371 Date: May 18, 2023

(30) Foreign Application Priority Data
Jan. 18, 2021 (NO) 20210057

(51) Int. Cl. B65G 1/04; B65G 1/06; B65G 57/30

(52) U.S. Cl. CPC B65G 1/0471; B65G 57/302; B65G 1/065; B65G 1/0492

(57) ABSTRACT

A storage container handling system includes a base, and a delivery vehicle configured to travel on the base. The delivery vehicle includes a rolling base unit, a container carrier, and an elevating device. The rolling base unit includes first and second sets of rolling means for guiding the delivery vehicle along the base in a first and second directions respectively. The container carrier is provided on the rolling base unit. The container carrier is configured to removably support a storage container from below. The elevating device is configured to move the container carrier vertically between an upper and a lower position relative to the base. The storage container handling system includes a temporary storage station for temporarily storing a storage container to be picked-up or dropped off by the delivery vehicle. The temporary storage station includes a fixed container support configured to removably support the storage container. A vertical distance between the base and the container support is set such that, when the delivery vehicle is positioned in a storage container transfer position below the container support of the temporary station, the weight of the storage container is on the container support when the container carrier is in the lower position and the weight of the storage container is on the container carrier when the container carrier is in the upper position. The elevating device is a rolling means displacement assembly connected to the first set of rolling means. The rolling means displacement assembly is configured to lift and lower the first set of rolling means relative to the second set of rolling means such that only the first set of rolling means traveling in a desired direction is in contact with the base, and such that the container carrier is in the upper position when the first set of rolling means is lowered and in contact with the base and he container carrier is in the lower position when the first set of rolling means is lifted.

### FIELD OF THE INVENTION

The present invention relates to an automated storage and retrieval system for storage and retrieval of containers, in particular to a temporary storage station for temporarily holding a storage container to be picked-up or dropped off by a delivery vehicle and a method of transferring a storage container between a delivery vehicle and a temporary storage station.

### BACKGROUND AND PRIOR ART

FIG. 1 discloses a typical prior art automated storage and retrieval system 1 with a framework structure 100 and FIGS. 5 and 6 disclose two different prior art container handling vehicles 201, 301 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked one on top of one another to form stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201, 301 are operated to raise storage containers 106 from, and lower storage containers 106 into, the storage columns 105, and also to transport the storage containers 106 above the storage columns 105.

The rail system 108 comprises a first set of parallel rails 110 arranged to guide movement of the container handling vehicles 201, 301 in a first direction X across the top of the frame structure 100, and a second set of parallel rails 111 arranged perpendicular to the first set of rails 110 to guide movement of the container handling vehicles 201, 301 in a second direction Y which is perpendicular to the first direction X.

Containers 106 stored in the columns 105 are accessed by the container handling vehicles through access openings 115 in the rail system 108. The container handling vehicles 201, 301 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301 comprises a vehicle body 201a, 301a, and first and second sets of wheels 201b, 301b, 201c, 301c which enable the lateral movement of the container handling vehicles 201, 301 in the X direction and in the Y direction, respectively. In FIGS. 5 and 6 two wheels in each set are fully visible. The first set of wheels 201b, 301b is arranged to engage with two adjacent rails of the first set 110 of rails, and the second set of wheels 201c, 301c is arranged to engage with two adjacent rails of the second set 111 of rails. At least one of the sets of wheels 201b, 301b, 201c, 301c can be lifted and lowered, so that the first set of wheels 201b, 301b and/or the second set of wheels 201c, 301c can be engaged with the respective set of rails 110, 111 at any one time.

Each prior art container handling vehicle 201, 301 also comprises a lifting device (not shown) for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201, 301 so that the position of the gripping/engaging devices with respect to the vehicle 201, 301 can be adjusted in a third direction Z which is orthogonal the first direction X and the second direction Y. Parts of the gripping device of the container handling vehicle 301 are shown in FIG. 6 indicated with reference number 304. The gripping device of the container handling device 201 is located within the vehicle body 201a in FIG. 5.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIGS. 1A and 1C, the storage container identified as 106′ in FIG. 1 can be said to occupy storage position X=10, Y=2, Z=3. The container handling vehicles 201, 301 can be said to travel in layer Z=0, and each storage column 105 can be identified by its X and Y coordinates.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301 comprises a storage compartment or space for receiving and stowing a storage container 106 when transporting the storage container 106 across the rail system 108. The storage space may comprise a cavity arranged centrally within the vehicle body 201a as shown in FIG. 5 and as described in e.g. WO2015/193278A1, the contents of which are incorporated herein by reference.

FIG. 6 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 5 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 201 may have a footprint which is larger than the lateral area defined by a storage column 105, e.g. as is disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

The rail system 108 may be a single rail system, as is shown in FIG. 2. Alternatively, the rail system 108 may be a double rail system, as is shown in FIG. 3, thus allowing a container handling vehicle 201 having a footprint generally corresponding to the lateral area defined by a grid column 105 to travel along a row of grid columns even if another container handling vehicle 201 is positioned above a grid column neighboring that row. Both the single and double rail system, or a combination comprising a single and double rail arrangement in a single rail system 108, forms a grid pattern in the horizontal plane P comprising a plurality of rectangular and uniform grid locations or grid cells 122, where each grid cell 122 comprises a grid opening 115 being delimited by a pair of tracks 110a, 110b of the first set of tracks 110 and a pair of tracks 111a, 111b of the second set of tracks 111. In FIGS. 3 and 4 the grid cell 122 is indicated by a dashed box.

Consequently, tracks 110a and 110b form pairs of tracks defining parallel rows of grid cells running in the X direction, and tracks 111a and 111b form pairs of tracks defining parallel rows of grid cells running in the Y direction.

As shown in FIG. 4, each grid cell 122 has a width W_{c} which is typically within the interval of 30 to 150 cm, and a length L_{c} which is typically within the interval of 50 to 200 cm. Each grid opening 115 has a width Wₒ and a length Lₒ which is typically 2 to 10 cm less than the width W_{c} and the length L_{c} of the grid cell 122.

In the X and Y directions, neighbouring grid cells are arranged in contact with each other such that there is no space there-between.

WO2018/146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301 lifting device 304 (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201, 301 so that a desired storage container 106 can be delivered to the desired location at the desired time without the container handling vehicles 201, 301 colliding with each other, the automated storage and retrieval system 1 comprises a control system 800 which typically is computerized and which typically comprises a database for keeping track of the storage containers 106.

A problem associated with known automated storage and retrieval system is that pick-up and drop off operations of storage containers between vehicles can be time consuming. re, cooperating vehicles, for example a delivery vehicle and a container handling vehicle, that exchange a storage container between one another, may not be available at the same time. This results in one vehicle having to wait for the other vehicle in order to transfer the storage container. The vehicle that has to wait for the transfer to occur has its availability for performing another task greatly reduced. This results in inefficiencies and reduces the operational cycle of the storage system as a whole.

A similar problem occurs at pick-up ports, where pick operations performed by for example an operator or other alternative means, may be time consuming. Delivery vehicles, transporting storage containers to be handled at the pick-up port, may have to be standstill while the pick operations are completed on the storage container they transport. In other situations, delivery vehicles might have to stand by for an available spot at the pick-up port, thus resulting in inefficiencies in the operations of the storage system.

A further problem is structural complexity of vehicles. Vehicles ridden with this particular problem are disclosed in WO05077789, WO14195867 and Italian patent application UD2013A000162.

In particular, WO05077789 describes an automated warehouse with a plurality of storage levels set on top of one another. The warehouse has at least one autonomous vehicle, which picks up, transfers and deposits load units and is provided with two set of wheels so as to be able to move in two mutually orthogonal directions. When it is empty, the vehicle can be lowered so as to be able to position itself underneath the load unit to be handled. A dedicated electrical motor brings about relative vertical displacement of a body of the vehicle. WO05077789 further discloses that a vertical displacement of a set of wheels is obtainable in analogous way, i.e. by introducing a further dedicated electrical motor.

In view of the above, it is desirable to provide an automated storage and retrieval system, and a method for operating such a system, that solve or mitigate the aforementioned problems related to use of prior art storage and retrieval system.

An objective is to provide an automated storage and retrieval system that increases the availability of container handling vehicles and delivery vehicles operating on a rail system.

Yet another objective is to provide an automated storage and retrieval system which increases the efficiency and facilitates the operation of transferring storage containers between vehicles.

A further objective is to provide an automated storage and retrieval system comprising vehicle of reduced number of components.

### SUMMARY OF THE INVENTION

The present invention is set forth and characterized in the independent claims, while the dependent claims describe other characteristics of the invention.

In a first aspect, the invention provides a storage container handling system comprising:
a base,
a delivery vehicle configured to travel on the base, the delivery vehicle comprising:
   a rolling base unit comprising first and second sets of rolling means for guiding the delivery vehicle along the base in the first and second directions (X, Y) respectively;
   a container carrier provided on the rolling base unit, the container carrier being configured to removably support a storage container from below; and
   an elevating device configured to move the container carrier vertically between an upper and a lower position relative to the base,
a temporary storage station for temporarily storing a storage container, or a plurality of storage containers, to be picked-up or dropped off by the delivery vehicle, the temporary storage station comprising a fixed container support configured to removably support the storage container;
wherein a vertical distance D between the base and the container support is set such that, when the delivery vehicle is positioned in a storage container transfer position below, or directly below, the temporary storage station, the weight of the storage container is on the container support when the container carrier is in the lower position and the weight of the storage container is fully or substantially fully on the container carrier when the container carrier is in the upper position,
wherein the elevating device is a rolling means displacement assembly connected to the first set of rolling means, and
wherein the rolling means displacement assembly is configured to lift and lower the first set of rolling means relative to the second set of rolling means such that only the first set of rolling means traveling in a desired direction is in contact with the base, and such that the container carrier is in the upper position and lower position when the first set of rolling means is lowered and lifted, respectively.

The present invention thus provides a storage container handling system with a temporary storage station for temporary storing a storage container. A storage container can be dropped off or picked-up by a delivery vehicle without any other assistance.

The base may be a rail system, a track system, a floor, or any other suitable base.

The delivery vehicle may be any vehicle having a rolling base unit, a container carrier and an elevating device. For example, it can be a robot cart (commonly referred to as a drone or robot cart in the prior art), or an automated guided vehicle, or a pick-up vehicle. It is understood that the delivery vehicle may arrive at the temporary storage from any direction.

The rolling means may be wheels or continuous tracks for example caterpillars' tracks, or other any suitable rolling means. The rolling means may be arranged around the periphery of the rolling base unit.

The container carrier of the delivery vehicle is movable between the lower and the upper position via the elevating device. The container carrier is configured to stably support the storage container during transport when delivery vehicle is moving on the base, and during transfer of the storage container between the delivery vehicle and the temporary storage station. The container may support one or more storage containers. The container carrier may be a plate, a tray or a similar suitable container carrier. The container carrier may have edges or walls to stably support the storage container and avoid lateral movement of the storage container during transport. The container carrier may also comprise a roller conveyor or a conveyor belt to reduce friction between the storage container and the container carrier during transfer of the storage container between the delivery vehicle and the temporary storage station.

The container support is arranged at a fixed level relative to the base at the vertical distance D above the base. The container support may have any shapes and dimensions, as long as it allows to stably support the storage container during temporary storage. Further, the dimension and shapes of the container support are such that a container carrier of a delivery vehicle, positioned below the container support, can move in the upper position or the lower position to pick-up or drop off a storage container from/to the container support.

The container support may be configured to support the storage container from below. However, other alternatives are also possible, for example the container support may also support the storage container from the bottom edge side rows of the storage container, from the sides of the storage container, and/or near to top edge rows of the storage container.

In the storage container transfer position, the delivery vehicle, and in particular the container carrier, is positioned below or directly below the container support. In the storage container transfer position, the storage container is arranged to be supported on the container carrier when the container carrier is in the upper position; and the storage container is arranged to be supported on the container support when the container carrier is in the lower position. Thereby making it possible to transfer the storage container between the temporary storage station and the delivery vehicle without other assistance.

The temporary storage station advantageously allows to temporally store a storage container, for example in the event a delivery vehicle is not ready to receive a storage container from another delivery vehicle or from a container handling vehicle, or if the container handling vehicle is not ready for retrieving a storage container from the delivery vehicle. This allow a vehicle (that has transferred a storage container to the temporary storage station) to carry other operations in the storage system, thereby increasing the overall efficiency of the system.

The temporary storage station may be arranged at, or adjacent to, a perimeter of the base, for example, integrated within a port or a grid interface of a storage grid. In general, the temporary storage station may be placed anywhere on or outside the base as long as the temporary storage station is within reach of the delivery vehicle.

The temporary storage station, when arranged at a port, allows a delivery vehicle to drop a storage container and temporary store that storage container, so that pick operations can be performed by an operator or a robot without the delivery vehicle having to be necessarily present at the port. That delivery vehicle thereby becomes available to perform other tasks, thus increasing the vehicle availability and efficiency of the storage system.

The container support of the temporary storage station is for removably supporting, or removably holding, or removably suspending, the storage container during temporary storage. The container support has a surface, where the storage container is resting on that surface. The container support may support one or more storage containers.

The temporary storage station may further comprise a support structure fixed at, or near, the base. The container support may be fixed perpendicularly to the support structure at the vertical distance D above the base. The support structure may be a vertically extending support structure, for example a support plate, a pedestal, or a framework structure integrated for example into a storage grid's framework structure.

Further, the support structure may comprise a lower end fixed at, or near, the base. The lower end of the temporary storage station may comprise a charging connection for charging the delivery vehicle batteries when the vehicle drops off or pick-up a storage container, or to charge the battery of the vehicle.

The temporary storage station may be one or a plurality of temporary storage stations. The plurality of storage stations may be arranged adjacent to each other, or separate from each other.

In one embodiment of the system, the elevating device is a rolling means displacement assembly connected to the first set of rolling means. The rolling means displacement assembly is configured to lift and lower the first set of rolling means relative to the second set of rolling means, such that only the first set of rolling means traveling in a desired direction (X) is in contact with the base, and such that the container carrier is in the upper position and lower position when the first set of rolling means is lowered and lifted, respectively.

In the storage container transfer position:
the storage container is arranged to be supported on the container support, when the first set of rolling means is in the upper rolling means position, and
the storage container is arranged to be separated from the container support and supported on the container carrier, when the first set of rolling means is in the lower rolling means position.

The rolling means displacement assembly may elevate the container carrier at any suitable height relative to the base.

In another configuration, the first and second set of rolling means may both be connected to a rolling means displacement assembly.

In one embodiment of the system, the rolling means displacement assembly is driven by an electric motor.

In one embodiment of the system, wherein the elevating device is a jack mechanism arranged between the rolling base unit and the container carrier, wherein the jack mechanism is arranged to move the container carrier vertically between the upper and the lower position, such that: when the jack mechanism is lowered and lifted, the container carrier is in the lower and upper position, respectively.

The jack mechanism may be a rack and pinion assembly, hydraulic or pneumatic assembly, or liner screws, configured to move the container carrier vertically between the upper and lower position.

In the storage container transfer position:
The storage container is arranged to be supported on the container support, when the jack mechanism moves the container carrier to the lower position.
The storage container is arranged to be separated from the container support and supported by the container carrier, when the jack mechanism moves the container carrier to the upper position.

In one embodiment of the system, the jack mechanism is driven by an electric motor powered by a power source, such as a suitable capacitor or a battery, wherein the electric motor is coupled to a drive assembly to transfer drive power to the jack mechanism, hence allowing the desired movement of the container carrier between the upper and lower position.

The suitable capacitor may be a rechargeable battery. The drive assembly may be a rack and pinion assembly.

In one embodiment of the system, the container support involves a set of two laterally extending guide supports onto which the storage container may be supported during temporary storage.

The storage container may be supported by the two laterally extending guide supports having a horizontal separation. The storage container may be supported from below by the guide supports. Alternatively or in addition to, the storage container may be supported from its bottom edge side rows by the guide supports. In yet another alternative, the storage container may be supported from its top edge side rows by the guide supports.

The two laterally extending guide supports extends a distance L from an outer perimeter of the support structure of the temporary charging station. Alternatively, when for example the base is a rail system, the distance L can be equal or near equal to the length of one or more grid cells.

The horizontal separation between the guide supports may be smaller, equal or near equal to a geometrical size of the storage container as mentioned above, for example equal or near equal to the width of the storage container. The two guide supports are preferably mutually aligned in the horizontal plane (P) of the base. In other configurations, the horizontal separation between the guide support may be larger. For example, when the base is a rail system, the horizontal separation between the guide supports may be one or more grid cells.

The end of each guide support may be wedge-shaped, to aid the insertion into the container carrier, for example when the container carrier is a tray. Note that wedge-shaped is defined as a tapered end surface relative to the guide supports' upper and lower surface. The container carrier may also have recess to interact with corresponding guide support of the temporary storage station.

In one embodiment of the system, the container support comprises a set of two laterally extending guide supports between which the transferable storage container may be supported.

In such a configuration, the storage container preferably comprises support ribs (or recesses) arranged on each of two opposite sides of the storage container, each support rib (or recess) arranged to interact with a corresponding guide support of the container support. The support ribs (or recesses) may extend laterally/horizontally at opposite sidewalls of the storage container.

In one embodiment of the system, the two laterally extending support are two laterally extending guide support shoulders facing opposite each other and oriented perpendicular to the container support.

In such a configuration, the storage container may rest on the support shoulder during temporary storage on the temporary station. For example, the guide support shoulder may support the container storage two opposite bottom edge side rows of the storage container.

In one embodiment of the system, wherein the temporary storage station further comprises a vertically extending support, and wherein the container support extends a distance L from an outer perimeter of the vertically extending support.

In one embodiment of the system, a lower end of the vertically extending support is fixed onto the base.

In one embodiment of the system, the vertically extending support is fixed to a rotatable pedestal.

In one embodiment of the system, the rotatable pedestal is fixed onto the base.

The rotating pedestal may be fixed onto the base such that when the pedestal rotates the container support of the temporary station is moved over the base. Having a rotating pedestal makes it possible to change the position of the container support over the base and makes it accessible by a delivery vehicle from different locations/positions on the base.

In one embodiment of the system, the base is a two-dimensional rail system comprising:
a first set of parallel rails arranged in a horizontal plane and extending in a first direction X, and
a second set of parallel rails arranged in the horizontal plane P and extending in a second direction Y which is perpendicular to the first direction X, said first and second sets of rails forming a grid pattern in the horizontal plane P comprising a plurality of adjacent grid cells, each grid cell comprising a grid opening.

In other word the base may be a rail system 108 as described in the background chapter further above.

In one embodiment of the system, an automated storage and retrieval system comprises:
a storage container handling system as described above,
an upper two-dimensional rail system arranged above the base, comprising
   a first set of parallel rails arranged in a horizontal plane P and extending in a first direction X, and
   a second set of parallel rails arranged in the horizontal plane P and extending in a second direction Y perpendicular to the first direction X,
   said first and second sets of rails forming a grid pattern in the horizontal plane P comprising a plurality of adjacent grid cells, each grid cell comprising a grid opening,
a plurality of stacks of storage containers arranged in storage columns beneath the upper rail system, wherein each storage column is located vertically below the grid opening;
a container handling vehicle comprising a lifting device for lifting a storage container stacked in the stacks and configured to drive the vehicle along the upper rail system in at least one of the first direction X and the second direction Y and
a delivery column for transport of the storage container between the upper rail system and the temporary storage station, wherein the temporary storage station is arranged at the base at the lower end of the delivery column.

In other word, the temporary storage station may be arranged at the lower end of a delivery column 119, 120 of an automated storage and retrieval system 1 as described in the background chapter further above.

In this configuration the container support can receive a storage container dropped by a delivery vehicle moving on the base, or dropped by a container handling vehicle moving on the upper rail system.

Having a temporary storage station arranged at the lower end of a delivery column advantageously allows to temporary store a storage container in the event the delivery vehicle is not ready to receive a storage container from a container handling vehicle, or if the container handling vehicle is not ready for retrieving the storage container from the delivery vehicle.

In one embodiment of the system, the delivery vehicle is further adapted to transport the storage container between a first location represented by the temporary storage station below the delivery column and a second location, wherein the second location is represented by a robotic port and/or an operator port for handling of product items in the storage container comprising a second temporary storage station for temporarily storage containers.

The second temporary storage station may be identical to the first temporary station.

Alternatively, the second temporary storage station may differ from the first temporary. For example, in one possible embodiment the container support of the second station may support more than one storage container while the first temporary storage station may support only one storage container. In another possible embodiment, the container support of the second station may support a storage container from opposite bottom edge side rows of the storage container, while the container support of the first station may support a storage container from the bottom surface of the storage container.

In one embodiment of the system, an automated storage and retrieval system:

comprises
a storage container handling system where the base is a two-dimensional rail system as described above,
a plurality of stacks of storage containers arranged in storage columns beneath the rail system, wherein each storage column is located vertically below the grid opening and
a container handling vehicle comprising a lifting device for lifting a storage container stacked in the stacks and configured to drive the vehicle along the rail system in at least one of the first direction X and the second direction Y,
wherein the temporary storage station is fixed on the two-dimensional rail system.

In a second aspect, the invention relates to a method of transferring a storage container between a delivery vehicle and a temporary storage station, the delivery vehicle being configured to move on a base comprising an automated storage and retrieval system,

the method comprising the following steps:
a) operating the elevating device such that the container carrier with a storage container supported thereon is in an upper position;
b) moving the delivery vehicle to a location on the base where the elevating device is arranged below the container support;
c) transferring the storage container from the container carrier to the container support by operating the elevating device from the upper position to the lower position; and
d) moving the delivery vehicle in opposite direction relative to step a). Thereby leaving the storage container at the temporary storage station.

In one embodiment of the method, the elevating device comprises the jack mechanism arranged between the rolling base unit of the delivery vehicle and the container carrier.

In this configuration, the jack mechanism is configured to move the container carrier vertically between the upper and lower position.

For transferring a storage container from the delivery vehicle to the temporary storage station, the jack mechanism is operated such that the container carrier with a storage container supported thereon is in an upper position in step a), and such that the jack mechanism move the container carrier in the lower position in step c) for transferring the storage container from the container carrier to the container support.

Alternatively, for transferring the storage container from the temporary storage station to the delivery vehicle, the jack mechanism is operated such that the container carrier without a storage container supported thereon is in an lower position in step a), and such that the jack mechanism moves the container carrier in the upper position in step c) for transferring the storage container from the container support to the container carrier.

In one embodiment of the method, the elevating device comprises the rolling means displacement assembly.

In this configuration, the rolling means displacement assembly is configured to move the container carrier vertically between the upper and lower position.

For transferring a storage container from the delivery vehicle to the temporary storage station, the rolling means displacement assembly is operated such that the container carrier with a storage container supported thereon is in an upper position in step a), and such that rolling means displacement assembly moves the container carrier in the lower position in step c) for transferring the storage container from the container carrier to the container support.

Alternatively, for transferring the storage container from the temporary storage station to the delivery vehicle, the rolling means displacement assembly is operated such that the container carrier without a storage container supported thereon is in an lower position in step a), and the rolling means displacement assembly moves the container carrier in the upper position in step c) for transferring the storage container from the container support to the container carrier.

Thus, for transferring the storage container from the temporary storage station to the delivery vehicle the following steps are used:
a) operating the elevating device such that the container carrier with a storage container supported thereon is in a lower position;
b) moving the delivery vehicle to a location on the base where the elevating device is arranged below the container support;
c) transferring the storage container from the container support to the container carrier by operating the elevating device from the lower position to the upper position; and
d) moving the delivery vehicle in opposite direction relative to step a). Thereby leaving the storage container on the delivery vehicle.

The combined movements of the elevating device and the delivery vehicle advantageously allows a storage container to be transferable between a position on the container carrier of the delivery vehicle and a position on the fixed container support of the temporary storage station without any other assistance.

In the following, numerous specific details are introduced by way of example only to provide a thorough understanding of embodiments of the claimed system and method. One skilled in the relevant art, however, will recognize that these embodiments can be practiced without one or more of the specific details, or with other components, systems, etc. In other instances, well-known structures or operations are not shown, or are not described in details to avoid obscuring aspects of the disclosed embodiments.

### BRIEF DESCRIPTION OF THE DRAWINGS

Following drawings are appended to facilitate the understanding of the invention. The drawings show embodiments of the invention, which will now be described by way of example only, where:

FIG. 1 shows a perspective view of a framework structure of a prior art automated storage and retrieval system.

FIG. 2 shows a top view of a prior art single rail grid.

FIG. 3 shows a top view of a prior art double rail grid.

FIG. 4 shows a top view of a track system of the automated storage and retrieval system according to FIG. 1.

FIG. 5 shows a perspective view of a prior art container handling vehicle having a centrally arranged cavity for carrying storage containers therein.

FIG. 6 shows a perspective view of a prior art container handling vehicle having a cantilever for carrying storage containers underneath.

FIG. 7A-C show exemplary perspective views of a remotely operated delivery vehicle with a rolling mean displacement assembly according to an embodiment of the invention.

FIGS. 8A and 8B show exemplary perspective views of a rolling base unit for the delivery vehicle, with a rolling means displacement assembly.

FIG. 9A-C show exemplary perspective views of a remotely operated delivery vehicle with a jack mechanism according to an embodiment of the invention.

FIGS. 10A and 10B are exemplary details perspective view of the jack mechanism of FIG. 9, in a lower position and upper position respectively.

FIGS. 11A and 11B show perspective views of exemplary embodiments of the temporary station according to the invention, where a storage container is support from its bottom edge side rows.

FIGS. 12A and 12B show side and front views of another exemplary embodiment of the temporary station according to the invention, where a storage container is supported from its bottom surface.

FIGS. 13A and 13B show side and front views of yet another exemplary embodiment of the temporary station according to the invention, where the storage container is supported from its top edge side row.

FIG. 14A-C show perspective views of yet another exemplary embodiment of the temporary station according to the invention, where the container support and the container carrier are configured to support multiple storage containers.

FIG. 15 shows a side view of an exemplary embodiment of the temporary storage station arranged at a grid interface of the storage system.

FIGS. 16A and 16B show perspective and side views of an exemplary embodiment of the temporary storage station arranged at a grid interface of the storage system, and a delivery vehicle using a jack mechanism as elevating device.

FIG. 17A-C show perspective views of an exemplary embodiment of the temporary storage station arranged at a grid interface and at a pick-up port, and a delivery vehicle using a jack mechanism as elevating device.

FIG. 18A-C show perspective views of an exemplary embodiment of the temporary storage station arranged at a grid interface, and a delivery vehicle using a rolling means displacement mechanism as elevating device.

FIG. 19A-C show perspective view of another exemplary embodiment of the temporary storage station arranged at a grid interface, and a delivery vehicle using a rolling means displacement mechanism as elevating device.

FIG. 20 shows perspective views of an exemplary embodiment of the temporary storage station arranged at a grid interface and at a pick-up port, and a delivery vehicle using a jack mechanism as elevating device that can transport a storage container between the grid interface, the pick-up port an a robotic port.

FIGS. 21A and 21B show perspective views of an exemplary embodiment of the temporary storage station comprising a pedestal that may rotate.

FIG. 22 shows a perspective view of the temporary storage station of FIGS. 21A and 21B arranged at a grid interface.

FIG. 23 shows a perspective view of the temporary storage station and an automated guide vehicle.

In the drawings, like reference numerals have been used to indicate like parts, elements or features unless otherwise explicitly stated or implicitly understood from the context.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

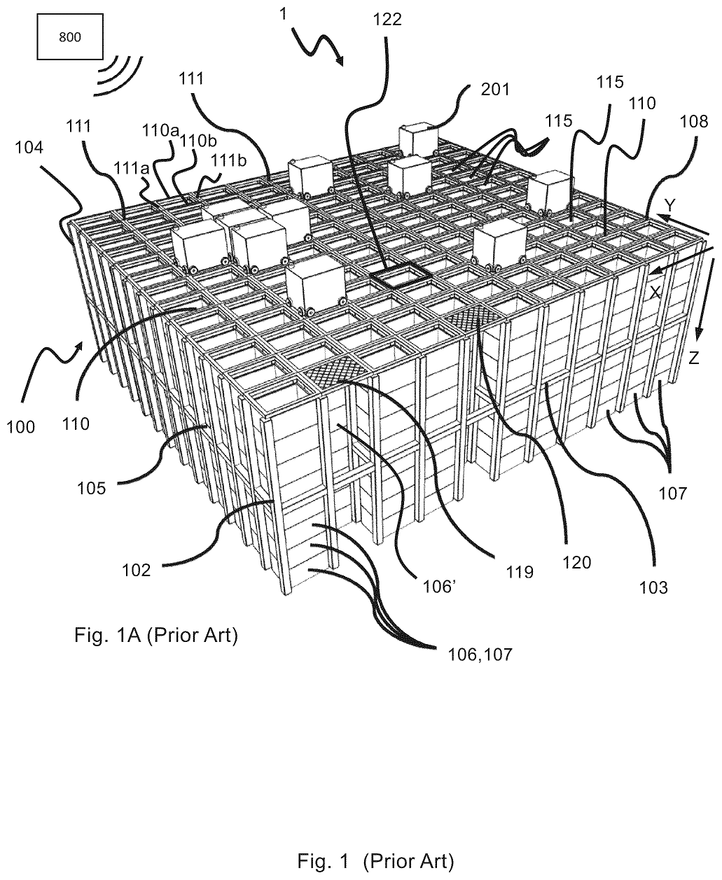

The framework structure 100 of the automated storage and retrieval system 1 is constructed in accordance with the prior art framework structure 100 described above in connection with FIGS. 1-6, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

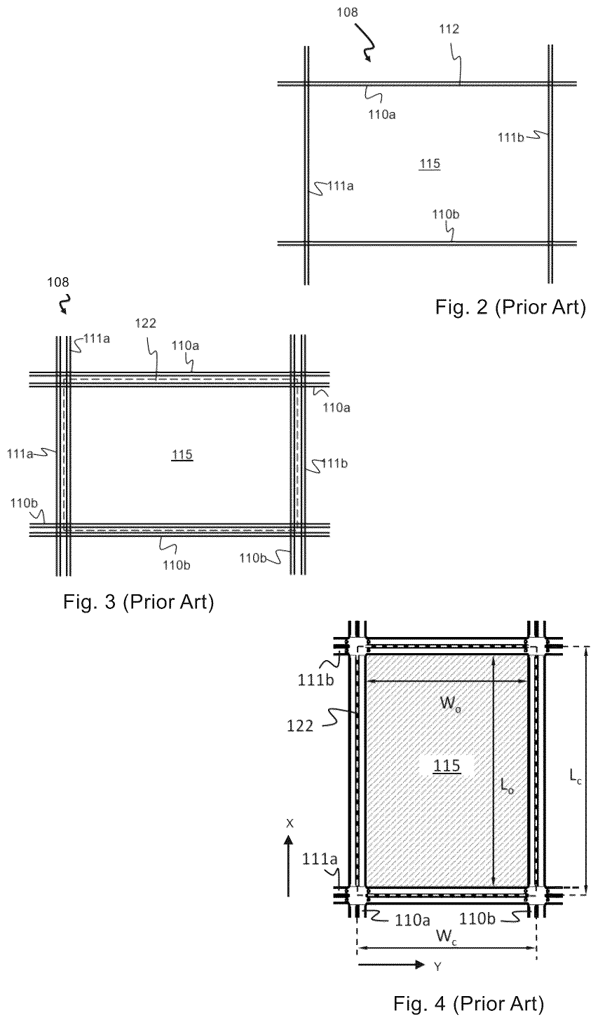

The rail system 108 may be a single rail (also denoted single track) system, as is shown in FIG. 2. Alternatively, the rail system 108 may be a double rail (also denoted double track) system, as is shown in FIG. 3, thus allowing a container handling vehicle 201 having a footprint generally corresponding to the lateral area defined by an access opening/grid column 112 to travel along a row of grid columns even if another container handling vehicle 201 is positioned above a grid column neighboring that row. Both the single and double track system, or a combination comprising a single and double track arrangement in a single rail system 108, forms a grid pattern in the horizontal plane P comprising a plurality of rectangular and uniform grid locations or grid cells 122, where each grid cell 122 comprises a grid opening 115 being delimited by a pair of tracks 110a, 110b of the first set of rails 110 and a pair of tracks 111a, 111b of the second set of rails 111. In FIG. 4 the grid cell 122 is indicated by a dashed box. For example, the sections of the rail-based system being made of aluminium are the rails, and on the upper surface of the rails, there are a pair of tracks that the wheels of the vehicle run in. However, the sections could be separate rails each with a track.

Consequently, tracks 110a and 110b form pairs of rails defining parallel rows of grid cells running in the X direction, and tracks 111a and 111b form pairs of rails defining parallel rows of grid cells running in the Y direction.

As shown in FIG. 4, each grid cell 122 has a width W_{c} which is typically within the interval of 30 to 150 cm, and a length L_{c} which is typically within the interval of 50 to 200 cm. Each grid opening 115 has a width Wₒ, and a length Lₒ which is typically 2 to 10 cm less than the width W_{c} and the length L_{c} of the grid cell 122.

In the X and Y directions, neighboring grid cells are arranged in contact with each other such that there is no space therebetween.

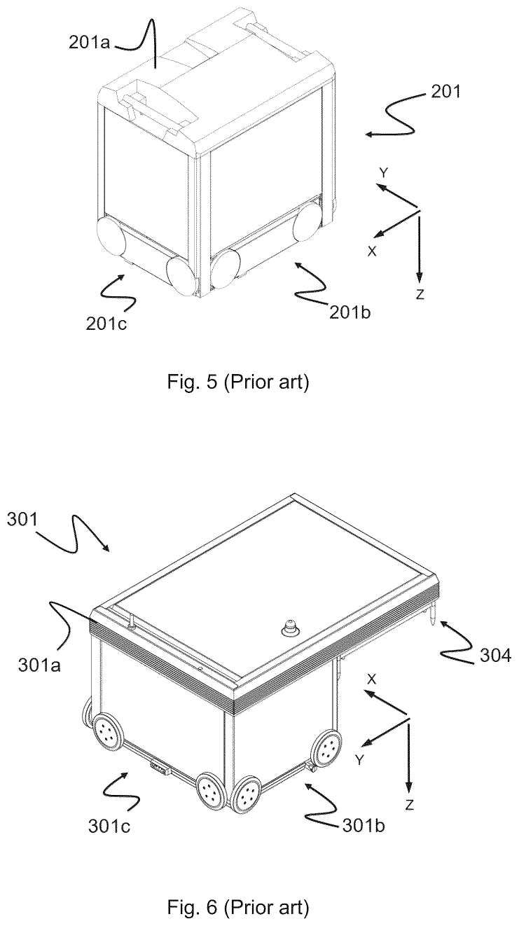

FIG. 5 is a perspective view of a prior art container handling vehicle 201 having a centrally arranged cavity for carrying storage containers therein.

FIG. 6 is a perspective view of a prior art container handling vehicle 301 having a cantilever for carrying storage containers underneath. The storage container vehicles 200, 300 may be of any type known in the art, e.g. any one of the automated container handling vehicles disclosed in WO2014/090684A1, in NO317366 or in WO2015/193278A1.

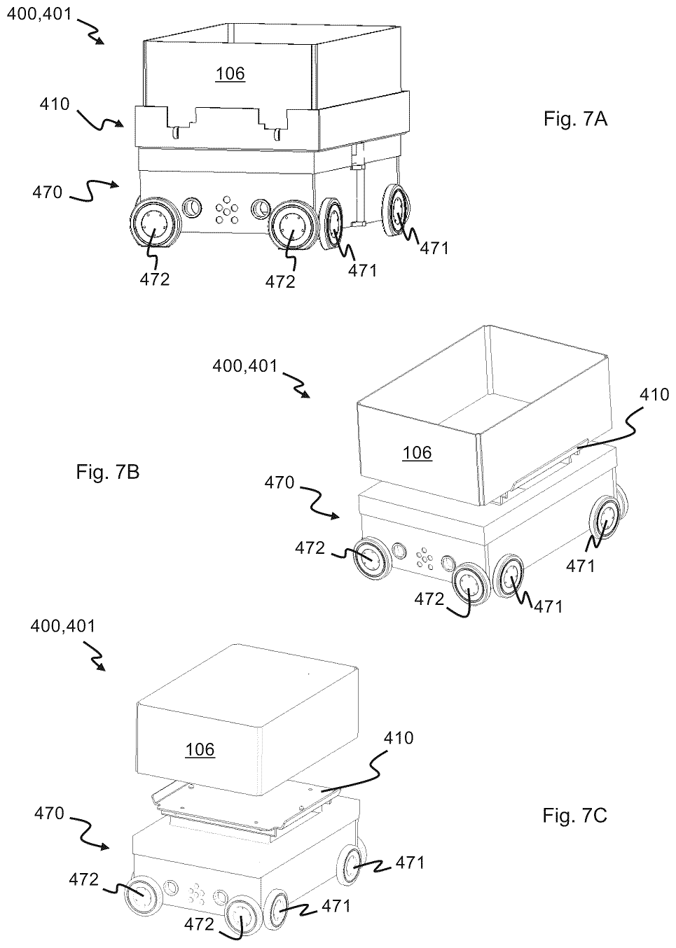

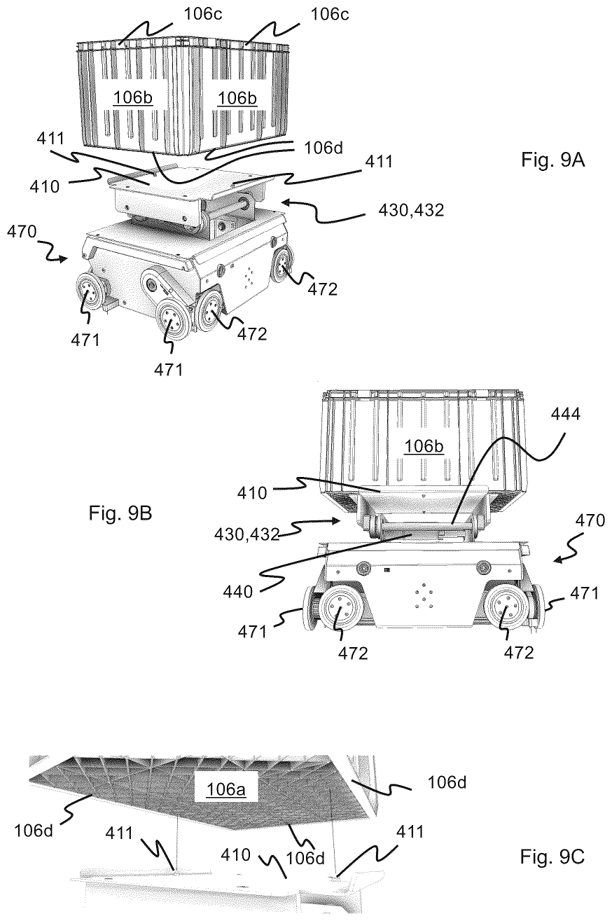

FIG. 7A-C and FIG. 9A-B shows respectively two exemplary embodiments 401,402 of a remotely operated delivery vehicle 400 according to the present invention.

The delivery vehicle 400 is configured to travel on the rail system 108. The delivery vehicle 400 comprises: a rolling base unit 470 comprising first and second sets of rolling means 471, 472 for guiding the delivery vehicle 400 along the rail system 108 in the first and second directions X, Y respectively; a container carrier 410 provided on the rolling base unit 470, the container carrier 410 being configured to removably support a storage container 106 from below; and an elevating device 430 configured to move the container carrier 410 vertically between an upper and a lower position relative to the rail system.

The delivery vehicle 400 may be configured for transporting of one or more storage container 106, for example the delivery vehicle may comprise more than one container carriers 410, and/or may be configured for transporting one or more storage container on a container carrier.

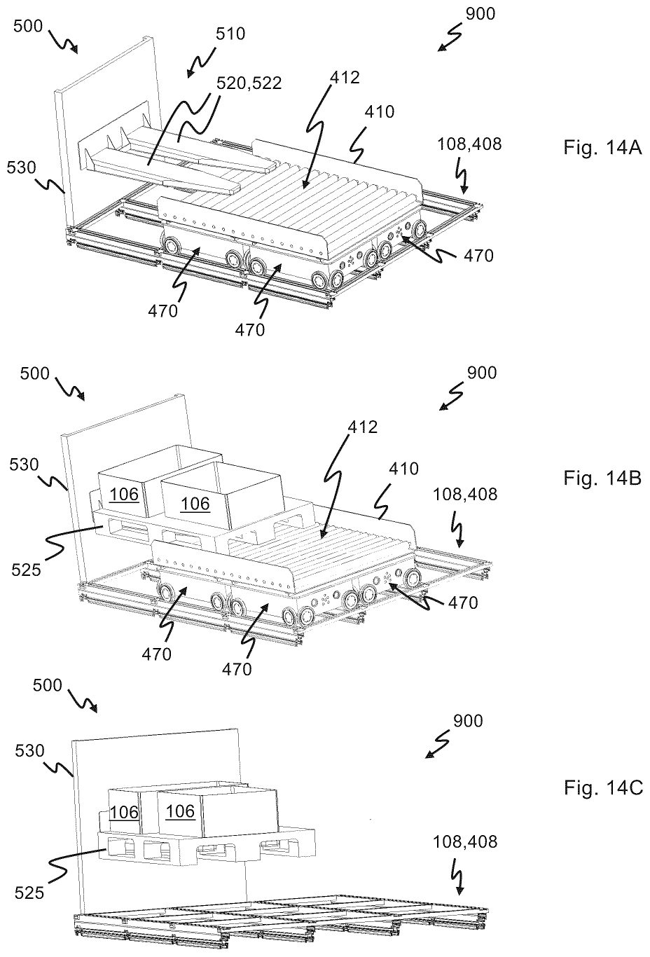

The container carrier 410 may arranged above the rolling base unit 470 as illustrated in FIG. 7A-C and FIG. 9A-B, or above one or more rolling base units 470 as shown on FIG. 14A-C. The container carrier 410 may take the form of a tray as shown on FIG. 7A, or a plate as shown in FIGS. 7B and 7C as well as in FIGS. 9A and 9B, or may have any other forms that ensure stable support of the storage container, for example a tray as shown in FIG. 7A, or a plate with edges as shown in FIG. 7B, 7C and FIG. 9 A-C. The container carrier 410 may further comprise a roller conveyor 412 as shown on FIG. 14A-C to reduce friction between the container carrier and the storage container. Furthermore, the container carrier 410 may also comprise one or more pins 411 as shown on FIG. 9C to interact with corresponding holes at the bottom surface 106a of the storage container 106 and hold the storage container into a stable position onto the container carrier 410.

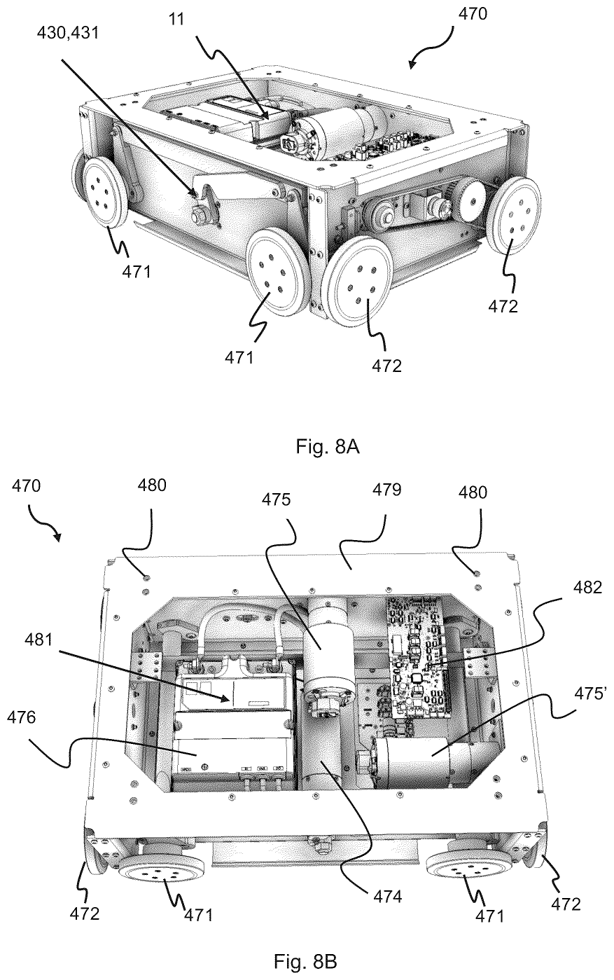

An exemplary rolling base unit 470 for a delivery vehicle 400 is shown in FIGS. 8A and 8B. The rolling base unit 470 has a first set of rolling means 471 for movement in a first direction upon a base 408 and a second set of wheels 472 for movement in a second direction perpendicular to the first direction. Each set of rolling means comprises two pairs of rolling means arranged on opposite sides of the rolling base unit 470. To change the direction in which the rolling base unit 470 may travel upon the base 408, one of the sets of rolling means 471 is connected to a rolling means displacement assembly 431. The rolling means displacement assembly 431 is able to lift and lower the connected set of wheels 471 relative to the other set of wheels 472 such that only the set of rolling travelling in a desired direction is in contact with the rail system. The rolling means displacement assembly 431 is driven by an electric motor 474. Further, two electric motors 475, 475′, powered by a rechargeable battery 476, are connected to the set of wheels 471, 472 to move the rolling base unit 470 in the desired direction.

In another configuration, the rolling base unit 470 may comprise a second (not shown) rolling means displacement assembly 431 such that both sets of rolling means are connected to a rolling means displacement assembly 431. Such configuration allows the delivery vehicle 400, 401, 402 to approach the temporary storage station 500 of the invention from both the X and Y directions.

Further referring to FIGS. 8A and 8B, the horizontal periphery of the rolling base unit 470 is dimensioned to fit within the horizontal area defined by a grid cell, such that two rolling base units 470 may pass each other on any adjacent grid cells of the rail system 108. In other words, the rolling base unit 470 may have a footprint, i.e. an extent in the X and Y directions, which is generally equal to the horizontal area of a grid cell, i.e. the extent of a grid cell in the X and Y directions, e.g. as is described in WO2015/193278A1, the contents of which are incorporated herein by reference.

Further referring to FIGS. 8A and 8B, the rolling base unit 470 has a top panel/flange 479 (i.e. an upper surface) configured as a connecting interface for connection to the container carrier 410 of the delivery vehicle 400. The top panel 479 have a centre opening 481 and features multiple through-holes 480 (i.e. connecting elements) suitable for a bolt connection via corresponding through-holes in a lower section of the container carrier 410, or a lower section of a body unit of the delivery vehicle 400, 401, 402, wherein the container carrier 410 is arranged on the body unit.

FIG. 7A and B shows an exemplary embodiment of the delivery vehicle 400, 401 where the elevating device 430 is the rolling means displacement assembly 431 as described above. By lowering the first set of rolling means 471, the rolling base unit 470 is elevated above the rail system 108, and thereby the container carrier 410 is also elevated above the rail system 108 into an upper position relative to the rail system 108. By lifting the first set of rolling means 471, the rolling base unit 470 is lowered, and thereby the container carrier 410 is also lowered to the lower position relative to the rail system 108.

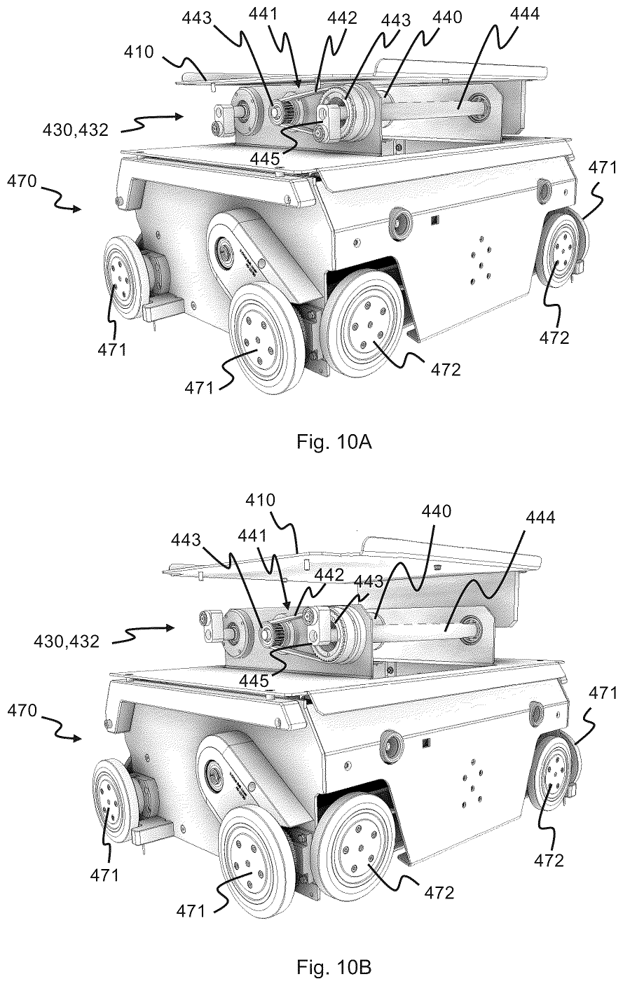

FIG. 9A-C as well as FIGS. 10A and 10B show an exemplary embodiment of the delivery vehicle 400, 402 wherein the elevating device 430 is a jack mechanism 432.

In such a configuration, the jack mechanism 432 is arranged between the rolling base unit 470 and container carrier 410. The delivery vehicle 400, 402 may comprise both a rolling displacement assembly 431 and a jack mechanism 432 as shown on FIG. 9 A-C and FIG. 10A-B.

The jack mechanism 432 is configured to elevate the container carrier 410 between a lower position relative to the rail system as shown on FIG. 10A, and an upper position as shown on FIG. 10B.

Further referring to FIGS. 10A and 10B, the jack mechanism 432 may be driven by an electric motor 440. The electric motor 440 is powered by a suitable capacitor (not shown on FIG. 10). The suitable capacitor may the rechargeable battery 476 arranged in the rolling base unit 470. The electric motor 440 is coupled to a drive assembly 441. The drive assembly 441 may be a rack and pinion assembly as illustrated on FIGS. 10A and 10B, wherein the rack and pinion assembly rotate an axle 444. Said axle 444 may have at one or both ends a torsion arm 445 connected to the container carrier 410, such that when the torsion arm 445 rotates the container carrier 410 is moved between an lower position as shown on FIG. 10A and a upper position as shown on FIG. 10B.

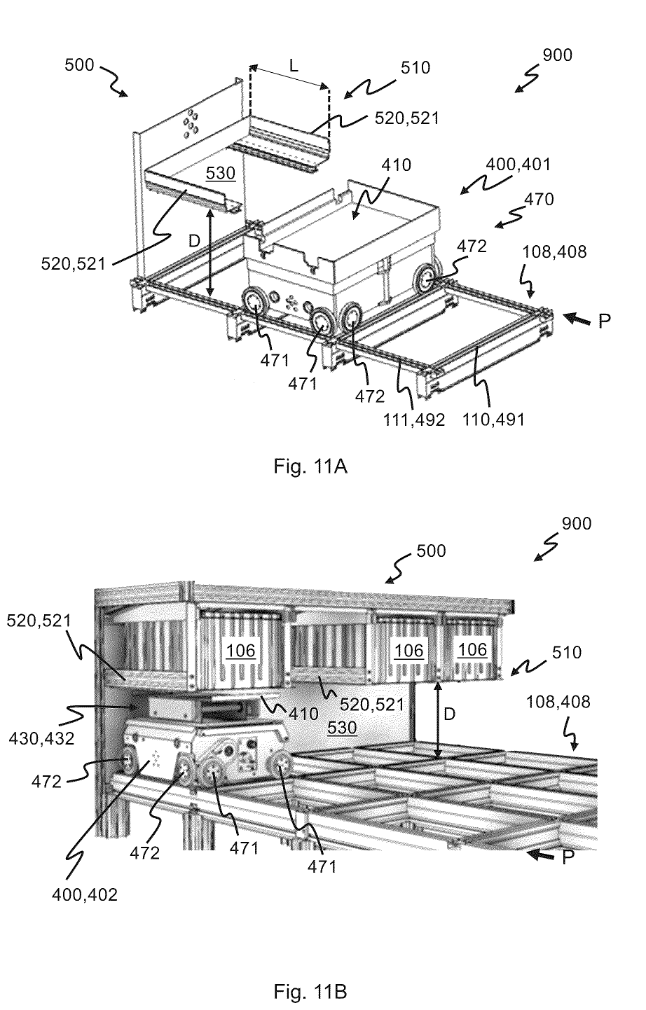

FIGS. 11A and 11B show exemplary embodiments of the temporary station 500 according to the invention where the storage container is supported from two of its bottom edge side rows.

FIG. 11A illustrates a temporary storage station 500 having a vertically extending support 530 and a delivery vehicle 400, 401 as previously described using a rolling means displacement assembly 431 (not shown) as elevating device 430. The temporary storage station is shown as having a vertically extending support 530, wherein a lower end of the vertically extending support 530 is arranged at the perimeter of a rail system 108. The temporary storage station 500 has a container support 510 being two lateral extending guide supports 520.

In the exemplary embodiment shown in FIG. 11A, the guide supports 520 are guide shoulders 521, i.e. they have a L-shaped profile. The guide shoulders 531 are oppositely facing each other and are arranged at the vertical distance D (as shown by the arrow on FIG. 11A) and extend from the vertically extending support 530 at a horizontal distance L (as shown by the arrow on FIG. 11A) from the vertically extending support 530.

Further referring to FIG. 11A, the container support 510 is arranged at a fixed level relative to the rail system 108, and the container carrier 410 of the delivery vehicle 400, 401 is movable between a lower and upper position as previously described by using the rolling means displacement assembly 431.

When the container carrier 410 is in the upper position, and when the delivery vehicle 400, 401 is positioned in a storage container transfer position below the container support 510, the storage container 106 is supported from below by the container carrier 410 of the delivery vehicle 400, 401.

When the container carrier 410 is in the lower position, and when the delivery vehicle 400, 401 is positioned in a storage container transfer position below the container support 510, the storage container 106 is supported from two opposite bottom edge side rows by the container support 510.

FIG. 11B illustrates a temporary storage station 500 having a vertically extending support 530 and a delivery vehicle 400, 402 as previously described using a jack mechanism 432 as elevating device 430. The temporary storage station is shown as having a vertically extending support 530, wherein a lower end of the vertically extending support 530 is arranged at the perimeter of the rail system 108.

In FIG. 11B, the temporary storage station 500 is shown as having four container supports 510, where each container support comprises two lateral extending guide supports 520. In the exemplary embodiment shown in FIG. 11A, the guide supports 520 are guide shoulders 521, i.e. they have a L-shaped profile. The guide shoulders 521 are oppositely facing each other and are arranged at a vertical distance D (as shown by the arrow on FIG. 11A) and extend from the vertically extending support 530 at a horizontal distance L from the vertically extending support 530. Further in the configuration shown on FIG. 11B, the guide supports are parts of a frame structure dimensioned to receive the storage container 106.

Further referring to FIG. 11B, the container support 510 is arranged at a fixed level relative to the rail system 108, and the container carrier 410 of the delivery vehicle 400, 402 is movable between a lower and upper position as previously described by using the jack mechanism.

When the container carrier is in the upper position, and when the delivery vehicle 400, 402 is positioned in a storage container transfer position below the container support 510, the storage container 106 is supported from below by the container carrier 410 of the delivery vehicle 400, 402.

When the container carrier is in the lower position, and when the delivery vehicle 400, 402 is positioned in a storage container transfer position below the container support 510, the storage container 106 is supported from two opposite bottom edge side rows by the container support 510, as shown on FIG. 11B.

In both FIGS. 11A and 11B, the container support 510, 520 is arranged to support a storage container from its bottom edge side row 106d.

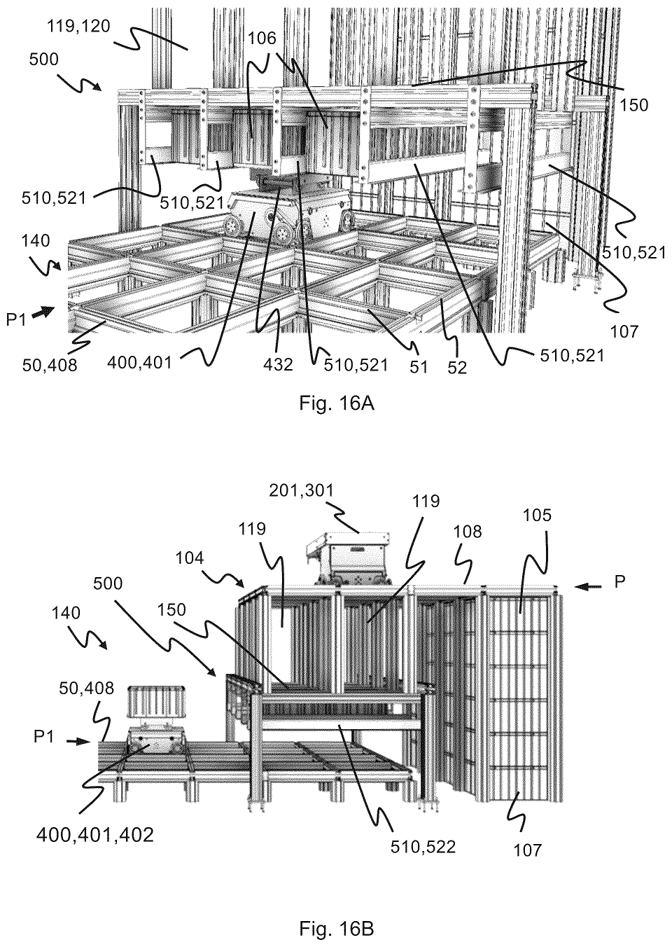

As shown in FIGS. 11A and 11B, and further on FIGS. 16, 17 and 20, the temporary storage station may comprise one or more container supports 510. Alternatively or in addition, the system of the present invention may comprises one or more temporary storage station arranged next to each other, and or separate from each other and arranged at different location on the storage grid.

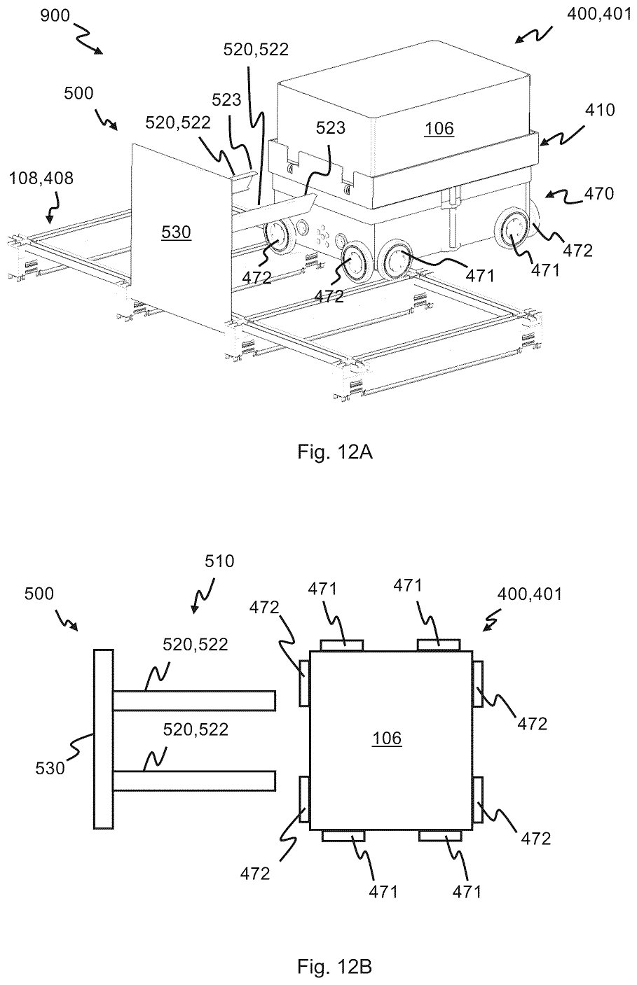

FIGS. 12A and 12B show side and front views of another exemplary embodiment of the temporary station 500 according to the invention, where the storage container is supported from its bottom surface 106a. The temporary storage station 500 has a vertically extending support 530 and a delivery vehicle 400, 401 as previously described that uses a rolling means displacement assembly 431 (not shown) as elevating device 430. The temporary storage station has a vertically extending support 530, wherein a lower end of the vertically extending support 530 is arranged at the rail system 108. The container support 510 involves two lateral extending guide supports 520.

In the exemplary embodiment shown in FIG. 12A, the guide supports 520 are guide arms 522. The guide arms 522 may have a wedge-shape end 523 extending beyond a section of the guide arms by which the storage container may be supported. The guide arms 522 are oppositely facing each other and are arranged at the vertical distance D above the rail system 108 and extend from the vertically extending support 530 at a horizontal distance L from the vertically extending support 530. The horizontal separation of the guide arms 522 is smaller than the width of the storage container 106 and such that the storage container 106 is stably supported from its bottom surface 106a on the guides arms.

Further referring to FIGS. 12A and 12B, the guide arms 522 are arranged at a fixed level relative to the rail system 108, and the container carrier 410 of the delivery vehicle 400, 401 is movable between a lower and upper position as previously described by using the rolling means displacement assembly 431.

When the container carrier 410 is in the upper position, and when the delivery vehicle 400, 402 is positioned in a storage container transfer position below the container support 510, the storage container 106 is supported from below by the container carrier 410 of the delivery vehicle 400, 402.

When the container carrier is in the lower position, and when the delivery vehicle 400, 402 is positioned in a storage container transfer position below the container support 510, the storage container 106 is supported from below by the guide arms 522.

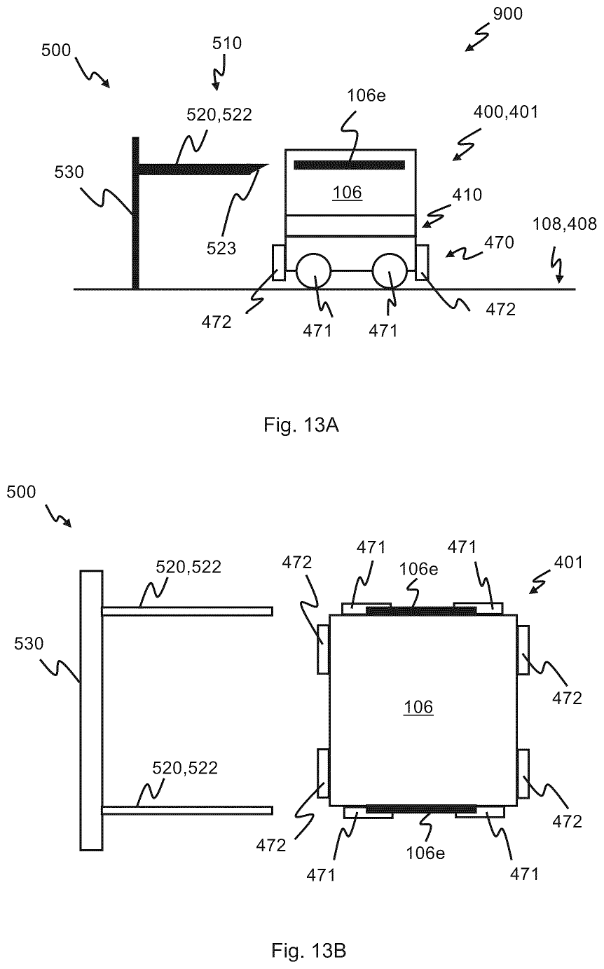

FIGS. 13A and 13B show side and front schematic views of yet another exemplary embodiment of the temporary station 500 according to the invention, where the storage container 106 is supported from its top edge side rows.

The embodiment shown in FIG. 13A is similar to the embodiment shown in FIG. 11A, expect that in the embodiment of FIGS. 13A and 13B the guide supports 520 are guide arms 522 between which the storage container may be supported. Said guide arms are configured to support the container storage 106 from two opposite top edge side rows 106c. In such a configuration, the storage container may comprise support ribs or rails 106e arranged on each of two opposite top edge side rows 106e of the storage container 106. Each support rib/rail 106e is arranged to interact with a corresponding guide arm 522 of the container support 510. The support ribs may extend laterally/horizontally at opposite sidewalls of the storage container.

In another alternative configuration (not shown), the storage container 106 may be supported from two opposite sides 106b.

FIG. 14A-C show perspective views of yet another exemplary embodiment of the temporary station 500 according to the invention, where the container support 510 and the container carrier 106 are configured to support multiple storage containers. The embodiment shown in FIG. 14A-C are similar to the embodiment shown in FIG. 12A.

FIG. 14A shows a temporary storage station 500 and four delivery vehicles 400 supporting one container carrier 410 having a footprint equal or near equal to the footprint of the four delivery vehicles. The delivery vehicles 400 may use a rolling means displacement assembly 431 and/or a jack mechanism 432 as elevating device 430 for moving the container carrier 410 between an upper and lower position as previously described. A control system may control a simultaneous movement of the elevating devices arranged on each delivery vehicle, so that the container carrier 410 remains in a horizontal plan when elevated or lowered. The container carrier 410 may further comprise conveyer rollers 412. The temporary storage station 500 comprises a vertically extending support 530 and two guide arms 520, 522. The two guides arms 522 have a horizontal separation configured to interact with corresponding recess of a pallet 525.

In FIG. 14C and D the pallet 525 is shown having a footprint near equal the footprint of the container carrier 410, however other configuration/dimensions are also possible. The pallet 525 may support one or more storage containers 106.

The pallet 525, that may support one or more storage containers 106, can be transferred between the delivery vehicles 400 and the temporary storage station 500. Transferring the pallet 525 from the container carrier 410 to the container support 510 may be achieved by:
elevating the container carrier 410 supporting a pallet 525 with one or more storage container 106 to an upper position using the elevating devices of the delivery vehicles;
moving the delivery vehicles such that the guide arms 522 interact with the corresponding recess of the pallet 525 (as shown on FIG. 14B), and such that the pallet 525 can be stably supported onto the guide arms 522;
lowering the container carrier 410 such that the pallet 525 is supported by the guide arm 522 and such that the pallet 525 is released from the container carrier 410;
reversing the delivery vehicle, i.e. leaving the pallet 525 with storage container(s) at the temporary storage station 500, as shown on FIG. 14C.

Although FIGS. 12, 13 and 14 are all showing a delivery vehicle 400, 401 using a rolling means displacement assembly 431 as elevating device 430, it is understood that the same embodiments represented in said figures would also apply if the elevating device 430 was a jack mechanism 432.

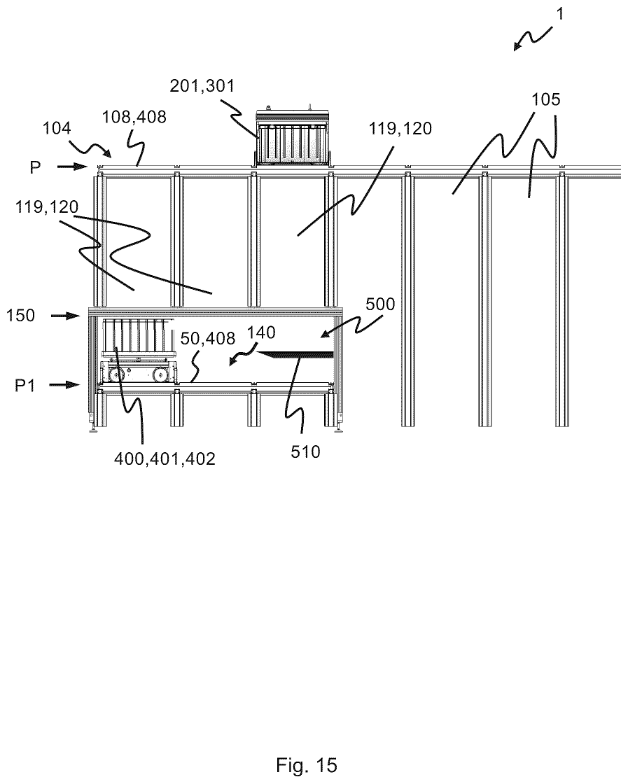

FIG. 15 shows a side view of an exemplary embodiment of the temporary storage station arranged below a delivery column.

In this configuration, the automated storage and retrieval grid 104 of the automated storage and retrieval system 1, further comprises a plurality of container handling vehicles 201, 301 operable on the rail system 108. The container handling vehicles 201, 301 being operable to retrieve a storage container 106 from a stack 107 (as shown on FIG. 1) of storage containers 106 beneath the rail system 108.

In addition, the automated storage and retrieval grid 104 comprises a delivery column 119, 120 below which a temporary storage station 500 is arranged, i.e. the temporary storage station 500 is arranged at the lower end of the delivery column 119, 120. The delivery column 119, 120 is adapted for transport of a storage container 106 between a container handling vehicle 201, 301 and the temporary storage station.

Further in the configuration shown on FIG. 15, the temporary storage station 500 at the lower end of the delivery column 119, 120 is fixed on a delivery system 140. The delivery system 140 comprises a rail system 108 being a delivery rail system 50, i.e. the delivery rail system 50 may be constructed in the same way or a similar way as the rail system 108 for the container handling vehicles 200, 300. Hence, the delivery rail system 50 also comprises a first set of parallel tracks 51 arranged in a horizontal plane P1 and extending in the first direction X, and a second set of parallel rails 52 arranged in a horizontal plane P1 and extending in the second direction Y which is orthogonal to the first direction X. The delivery vehicle is configured to travel on the delivery rail system 50.

Such configuration as shown in FIG. 15 allows a container handling vehicle 201, 301 operating on the rail system 108 to drop off or pick-up a storage container 106 to/from the temporary storage station 500 via the delivery column 119, 120. Similarly, a delivery vehicle 400, 401, 402 operating on the delivery rail system 50 can drop off or pick up a storage container 106 from the temporary storage station 500 arranged below the delivery column. Thus, the temporary storage station 500 below the delivery column 119/120 advantageously act as a buffer position in the event the delivery vehicle 400, 401, 402 is not ready to receive a storage container 106 from a container handling vehicle 201, 301 above or if the container handling vehicle 201, 301 is not ready for retrieving the storage container 106 from the delivery vehicle 400, 401, 402.

FIGS. 16A and 16B shows a perspective and side view of temporary storage station 500 arranged at the lower end of eight delivery columns 119, 120 forming a grid interface frame 150 located at the lower most level/end of the delivery column 119, 120. The temporary storage station 500 comprises four container supports 510 comprising two laterally extending guide shoulder 521 having an L-shaped profile fixed to the framework structure of the storage grid.

The temporary storage station of FIGS. 16A and 16B is similar to the one of FIG. 11B except that the length of the guide shoulder 521 of the temporary storage station of FIGS. 16A and 16B is equal or near equal the length of two grid cells. Each container support 510, 521 may support up to two storage containers 106.

Further, FIGS. 16A and 16B show a delivery vehicle 400, 402 having a jack mechanism 432. The delivery vehicle is operated and moving on a delivery rail system 50 of delivery system 140 as described above.

In FIG. 16A, the delivery vehicle 400, 402 is positioned below one container support 510, 521 with the jack mechanism 432 elevated to an upper position for picking up a storage container 106 from the temporary storage station 500.

In FIG. 16B, the delivery vehicle 400, 402 is shown arriving at or leaving the temporary storage station 500. Further, FIG. 16B show a container handling vehicle 301 operating on the rail system 108.

Such configuration as shown in FIGS. 16A and 16B allows a container handling vehicle 201, 301 operating on the rail system 108 to drop off or pick-up a storage container 106 to/from the temporary storage station 500 via one of the delivery columns 119, 120. Similarly, a delivery vehicle 400, 402 operating on the delivery rail system can drop off or pick up a storage container 106 from the temporary storage station 500 arranged below the delivery column. Thus, the temporary storage station 500 below the delivery column 119/120 advantageously act as a buffer position in the event the delivery vehicle 400, 402 is not ready to receive a storage container 106 from a container handling vehicle 201, 301 above or if the container handling vehicle 201, 301 is not ready for retrieving the storage container 106 from the delivery vehicle 400, 402. Further, the temporary storage station of FIGS. 16A and 16B allows to temporary store multiple storage containers at the grid interface frame 150.

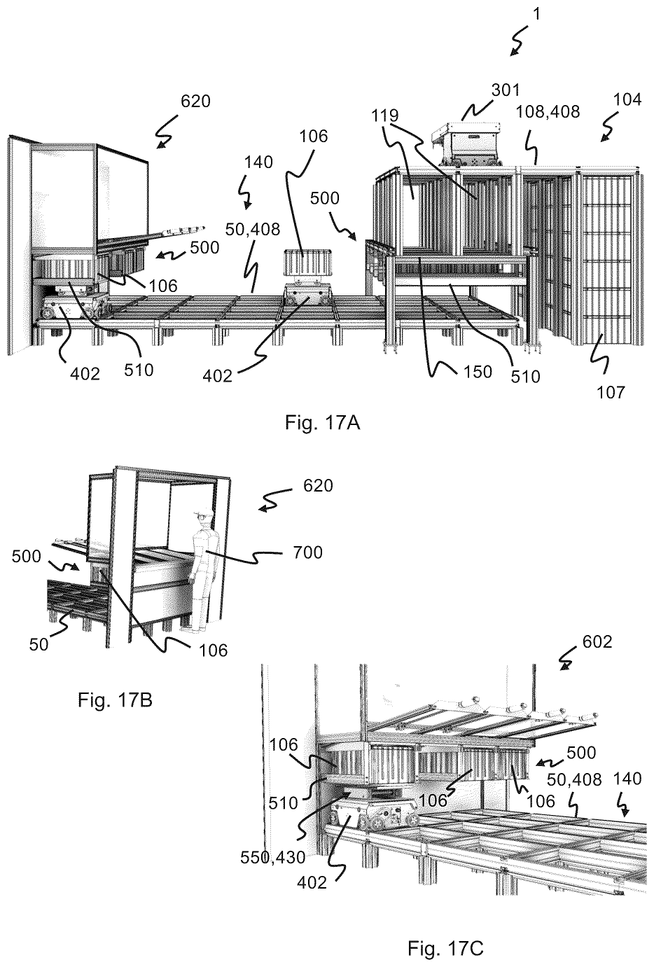

FIG. 17A is the same as FIGS. 16A and 16B, expect that FIG. 17A shows in addition a pick-up port 620, where an operator 700 may pick-up goods from storage container 106 as shown on FIG. 17B. The pick-up port 620 comprises a temporary storage station 500 as shown in FIG. 11B.

In the configuration shown on FIG. 17A, a container handling vehicle 301 (or alternative a container handling vehicle 201) may drop a storage container 106 on one of the container support 510 of the temporary storage station 500 arranged at the grid interface 150.

Further referring to FIG. 17A, a delivery vehicle 401 with a jack mechanism 432 can pick-up the storage container 106 from the temporary storage station 500 at the grid interface 150 and transport it to the temporary storage station 500 at the pick-up port 620. The delivery vehicle 402 can further drop-off the storage container 106 at the temporary storage station 500 of the pick-up port 620 as shown on FIG. 17C. An operator 700 may then perform necessary tasks such as the manual task of picking-up goods from the temporary stored storage container 106.

FIG. 17B shows the pick-up port 620 of FIG. 17A from a different angle, i.e. from the operator 700 side. FIG. 17C shows the temporary storage station 500 at pick-up port 620 as in FIG. 17A.

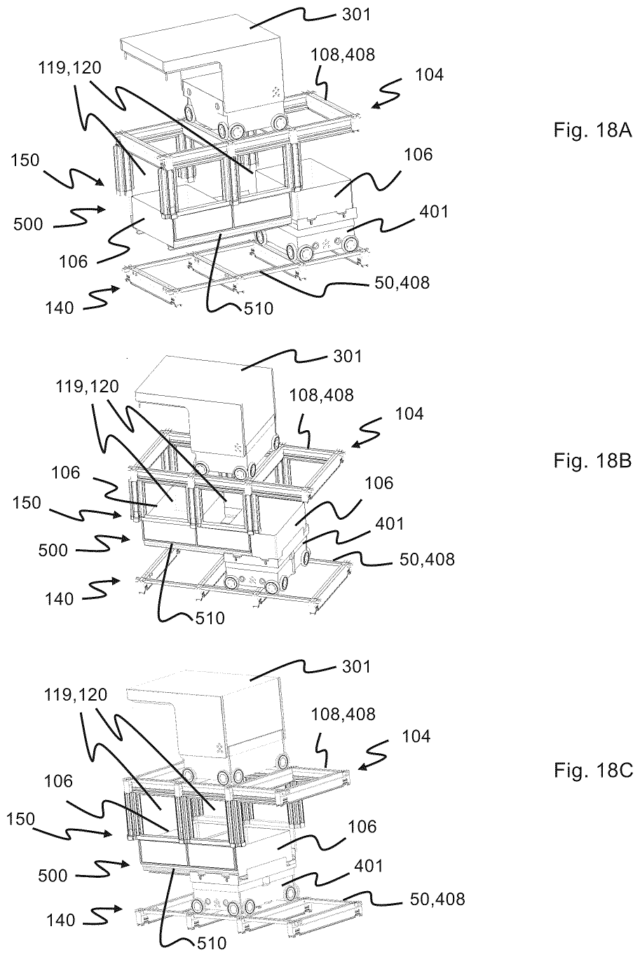

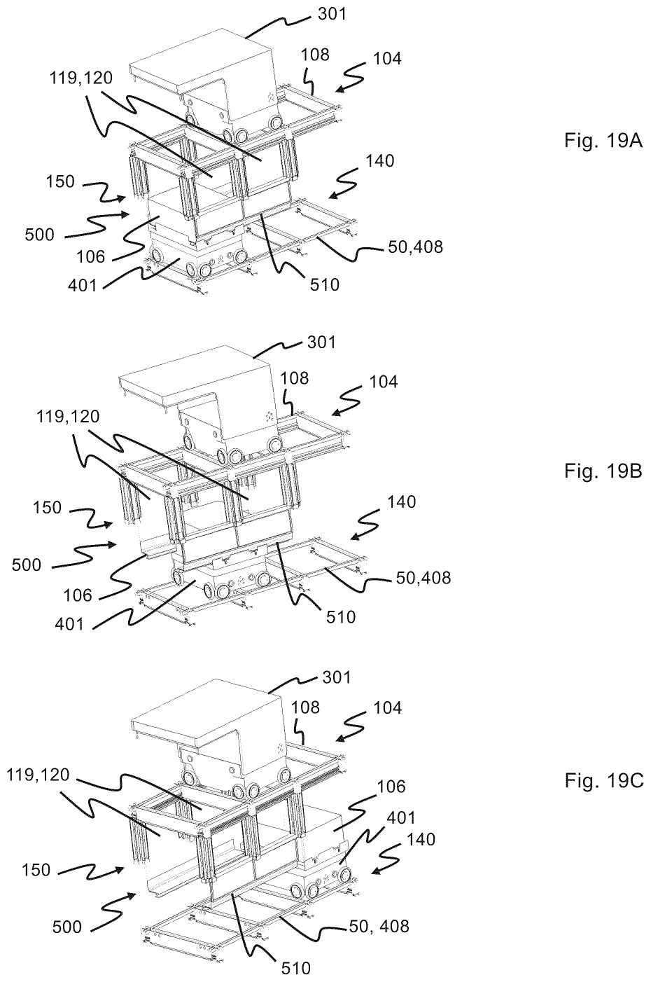

Although FIGS. 16A and 16B, as well as FIG. 17A-C show an embodiment using the delivery vehicle 402 with a jack mechanism 432 as elevating device, it should be understood that a delivery vehicle 401 with a rolling means displacement assembly 431 may also be used in such embodiment as illustrated in FIG. 18A-C and FIG. 19A-C.

FIG. 18A-C show a perspective views of a temporary storage station 500 arranged at the lower end of two delivery columns 119, 120 forming a grid interface frame 150 located at the lower most level/end of the delivery column 119, 120. The temporary storage station 500 is shown with one container support 510 being two laterally extending guide shoulder 521 having an L-shaped profile fixed to the framework structure of the storage grid, however the temporary storage station 500 may have multiple container support 510 in other configurations. The temporary storage station of FIG. 18A-C is similar to the one of FIGS. 16A and 16B as well as FIG. 17A. The length of the container support 510 of the temporary storage station of FIG. 18A-C is near equal or longer than the length of two grid cells and may store two storage containers 106 as shown on FIG. 18C.

Further, FIG. 18A-C show a delivery vehicle 400, 401 having a rolling means displacement assembly 431 as elevating mechanism 430. The delivery vehicle 400, 401 is operated and moving on a delivery rail system 50 of delivery system 140 as described above.

In the configuration shown on FIG. 18A-C, a container handling vehicle 301 (or alternative a container handling vehicle 201) may drop a storage container 106 on the container support 510 of the temporary storage station 500 arranged at the grid interface 150.

FIG. 18A shows the delivery vehicle 400, 401 arriving at the temporary storage station 500 at the grid interface 150 for dropping off a storage container 106.

FIG. 18B shows the delivery vehicle—with the container carrier 410 in the upper position—entering the temporary storage station 500, i.e. the container support 510 is extending into the container carrier 410 compartment.

FIG. 18C shows the delivery vehicle 401 position below the delivery column 119, 120. At this position, the elevating device 430, 431 can lower the container carrier 410 to the lower position and such that the storage container 106 is supported by the container support 510, thereby dropping off the storage container 106 at the temporary storage station 500. The delivery vehicle 400, 401 can reverse to leave the temporary storage station 500 and perform other tasks.

Referring to FIG. 19A-C, the delivery vehicle 400, 401, 402 with a rolling means displacement assembly 431 as elevating device 430 as shown on FIG. 19A-C, alternatively or in addition with a jack mechanism 432 as elevating device 430 (not shown), may also enter the temporary storage station 500 at one end of the container support 510 (as shown on FIG. 19A) to pick-up or drop off a storage container 106 and exist the temporary storage station at the other end (as shown on FIG. 19C).

The container support may further comprise means removing friction between the storage container 106 and the container support 510.

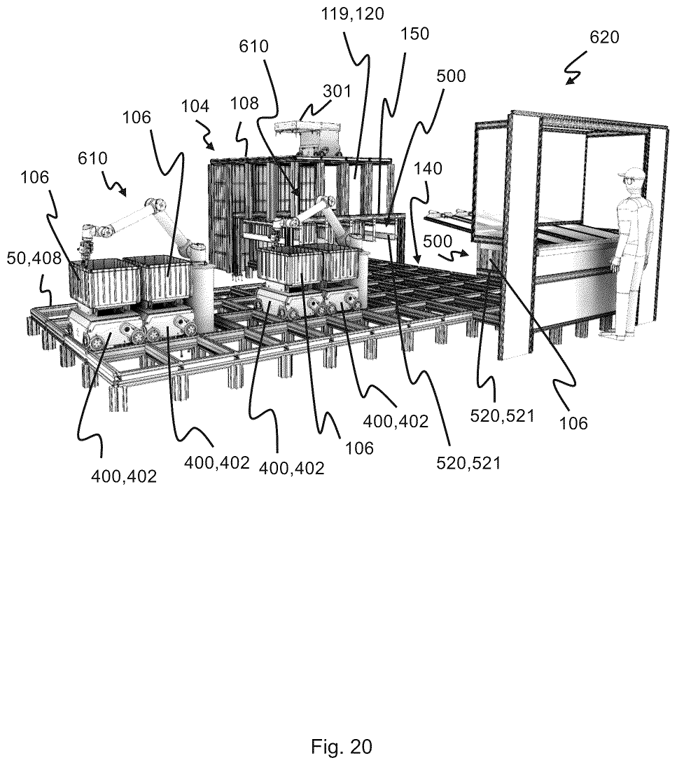

Further referring to FIG. 17A-C, FIG. 18A-C and FIG. 19A-C, instead of or in addition to picking-up and dropping off a storage container 106 between a grid interface frame 150 and a pick-up port 620, the delivery vehicle 400, 401, 402 may also transport the storage container 106 to a robotic port 610. The robotic port 610 may comprise a robot arm 611 for performing pick-up operation, for example picking up goods from one storage container and transferring it to another storage container—as shown on FIG. 20.

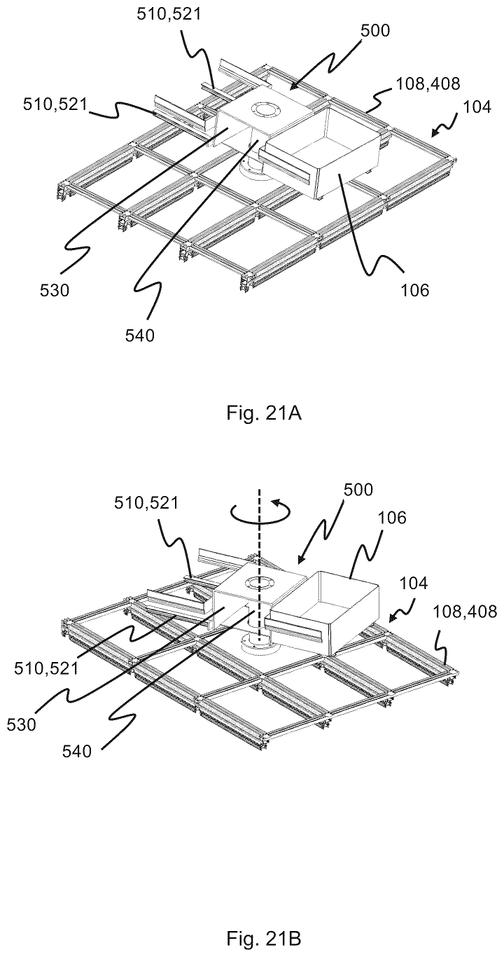

In other configurations, the temporary storage may further comprise a pedestal 540 as shown on FIG. 21A. The pedestal may rotate around its longitudinal axis as shown in FIG. 21B. Further, the temporary storage station 500 comprising a pedestal 540 may be arranged below a delivery column 119, 120 at a grid interface 150. Such configuration allows multiple container support 510 to be arranged at the pedestal. Further, a rotatable pedestal allows a container support to be accessible by a delivery vehicle 400, 401, 402 from different positions on the rail system 108.

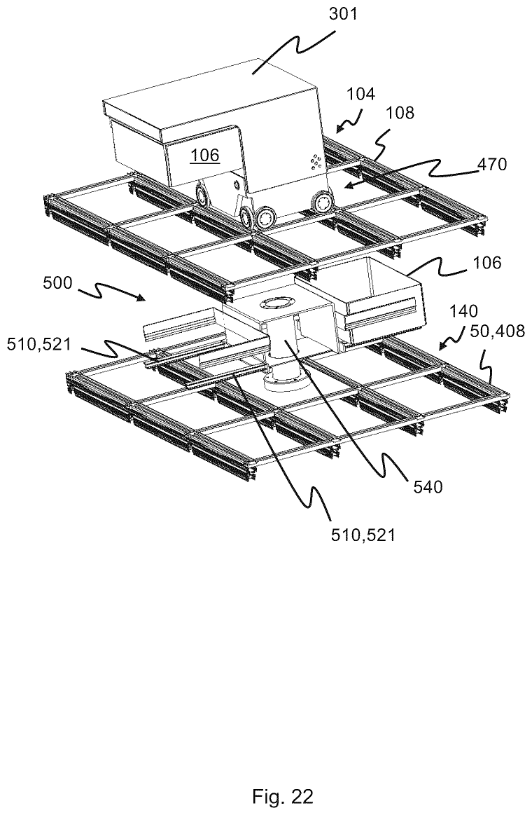

FIG. 22 shows the temporary storage station 500 of FIGS. 21A and 21B arranged below a delivery column 119, 120 at a grid interface 150.

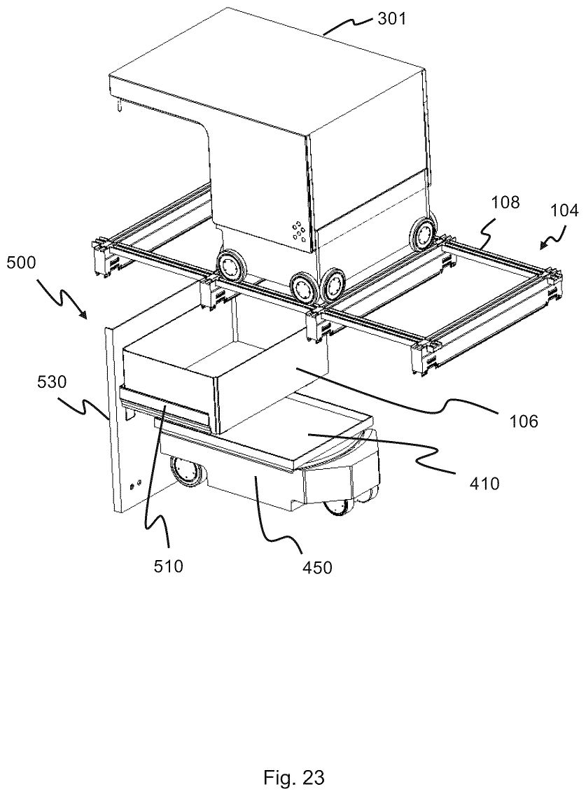

FIG. 23 shows that the temporary storage station 500 of FIG. 19 (in FIG. 23 the container surface extend over one grid cell) is suitable for use in junction with an automated guided vehicle 450 (AGV). In such configuration, the AGV comprises a container carrier 410 and a jack mechanism 432 (not visible on FIG. 23) as elevating device.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

LIST OF REFERENCE NUMBERS

| | |
|---|---|
| 1 | Prior art automated storage and retrieval system |
| 50 | Delivery rail system |
| 51 | First set of parallel rails (of the delivery system) |
| 52 | Second set of parallel rails (of the delivery system) |
| 100 | Framework structure |
| 102 | Upright members of framework structure |
| 103 | Horizontal members of framework structure |
| 104 | Automated storage and retrieval grid/Storage grid |
| 105 | Storage column |
| 106 | Storage container |
| 106′ | Particular position of storage container |
| 106a | Storage container bottom face/below face |
| 106b | Storage container side face |
| 106c | Storage container top edge |
| 106d | Storage container bottom edge side row |
| 106e | Support rail |
| 107 | Stack |
| 108 | Rail system |
| 110 | First set of parallel rails/parallel rails in first direction X |
| 110a | First rail in first direction (X) |
| 110b | Second rails in first direction (X) |
| 111 | Second set of parallel rails/parallel rails in second direction Y |
| 111a | First rail of second direction (Y) |
| 111b | Second rail of second direction (Y) |
| 115, 415 | Access opening/grid opening |
| 119 | First port column/delivery column |
| 120 | Second port column/delivery column |
| 122, 422 | Grid cell |
| 140 | Delivery system |
| 150 | Grid interface frame/Access station/transfer station |
| 201 | Prior art container handling vehicle |
| 201a | Vehicle body of the container handling vehicle 201 |
| 201b | Drive means/wheel arrangement, first direction (X) |
| 201c | Drive means/wheel arrangement, second direction (Y) |
| 301 | Prior art cantilever container handling vehicle |
| 301a | Vehicle body of the container handling vehicle 301 |
| 301b | Drive means in first direction (X) |
| 301c | Drive means in second direction (Y) |
| 304 | Gripping device |
| 400 | Delivery vehicle |
| 401 | Robot cart-delivery vehicle |
| 402 | Drone-delivery vehicle |
| 408 | Base |
| 410 | Container carrier |
| 411 | Pins |
| 412 | Roller conveyor |
| 430 | Elevating device |
| 431 | Rolling means displacement assembly |
| 432 | Jack mechanism |
| 440 | Electric motor for jack mechanism |
| 441 | Drive assembly/Rack and pinion assembly |
| 442 | Rack |
| 443 | Pinion |
| 444 | Axle |
| 445 | Torsion arm |
| 446 | Plate |
| 450 | Automated guided vehicle (AGV) |
| 470 | Rolling base unit |
| 471 | First set of rolling means |
| 472 | Second set of rolling means |
| 474 | First Electric motor |
| 475 | Second electric motor |
| 475′ | Third electric motor |
| 476 | Rechargeable battery |
| 479 | Top panel/flange |
| 480 | Through-holes |
| 481 | Centre opening |
| 482 | Electronic control system of the base |
| 491 | First set of parallel rails of the base |
| 492 | Second set of parallel rails |
| 500 | Temporary storage station |
| 510 | Container support |
| 520 | Guide supports |
| 521 | Guide shoulder/L-shaped profile |
| 522 | Guide arms |
| 523 | End of the laterally extending guide arm |
| 524 | Support rib |
| 525 | Pallet |
| 530 | Vertically extending support |
| 540 | Pedestal |
| 610 | Robotic Port |
| 611 | Robot arm |
| 620 | Pick-up port |
| 700 | Operator |
| 800 | Control system |
| 900 | Storage container handling system |
| P | Horizontal plane of track system 108 |
| P1 | Horizontal plane of delivery track system |
| X | First direction |
| Y | Second direction |
| Z | Third direction |

1. A storage container handling system comprising:
a base,
a delivery vehicle configured to travel on the base, the delivery vehicle comprising:
a rolling base unit comprising first and second sets of rolling means for guiding the delivery vehicle along the base in a first and second directions respectively;
a container carrier provided on the rolling base unit, the container carrier being configured to removably support a storage container from below; and
an elevating device configured to move the container carrier vertically between an upper and a lower position relative to the base,
a temporary storage station for temporarily storing a storage container to be picked-up or dropped off by the delivery vehicle, the temporary storage station comprising a fixed container support configured to removably support the storage container,
wherein a vertical distance between the base and the container support is set such that, when the delivery vehicle is positioned in a storage container transfer position below the container support of the temporary station, the weight of the storage container is on the container support when the container carrier is in the lower position and the weight of the storage container is on the container carrier when the container carrier is in the upper position,
wherein the elevating device is a rolling means displacement assembly connected to the first set of rolling means, and
wherein the rolling means displacement assembly is configured to lift and lower the first set of rolling means relative to the second set of rolling means such that only the first set of rolling means traveling in a desired direction is in contact with the base, and such that the container carrier is in the upper position when the first set of rolling means is lowered and in contact with the base and the container carrier is in the lower position when the first set of rolling means is lifted.

2. The storage container handling system according to claim 1, wherein the rolling means displacement assembly is driven by a first electric motor.

3. The storage container handling system according to claim 1, wherein the container support involves a set of two laterally extending guide supports onto which the storage container may be supported during temporary storage.

4. The storage container handling system according to claim 1, wherein the container support comprises a set of two laterally extending guide supports between which the transferable storage container may be supported.

5. The storage container handling system according to claim 1, wherein the two laterally extending support are two laterally extending guide support shoulders facing opposite each other and oriented perpendicular to the container support.

6. The storage container handling system according to claim 1,
wherein the temporary storage station further comprises a vertically extending support, and
wherein the container support extends a distance L from an outer perimeter of the vertically extending support.

7. The storage container handling system according to claim 6, wherein a lower end of the vertically extending support is fixed onto the base.

8. The storage container handling system according to claim 7, wherein the vertically extending support is fixed to a rotatable pedestal.

9. The storage container handling system according to claim 8, wherein the rotatable pedestal is fixed onto the base.

10. The storage container handling system according to claim 1, wherein the base is a two-dimensional rail system comprising:
a first set of parallel rails arranged in a horizontal plane and extending in a first direction, and
a second set of parallel rails arranged in the horizontal plane and extending in a second direction which is perpendicular to the first direction, said first and second sets of rails forming a grid pattern in the horizontal plane comprising a plurality of adjacent grid cells, each grid cell comprising a grid opening.

11. An automated storage and retrieval system comprising:
a storage container handling system comprising:
a base,
a delivery vehicle configured to travel on the base, the delivery vehicle comprising:
a rolling base unit comprising first and second sets of rolling means for guiding the delivery vehicle along the base in a first and second directions respectively;
a container carrier provided on the rolling base unit, the container carrier being configured to removably support a storage container from below; and
an elevating device configured to move the container carrier vertically between an upper and a lower position relative to the base,
a temporary storage station for temporarily storing a storage container to be picked-up or dropped off by the delivery vehicle, the temporary storage station comprising a fixed container support configured to removably support the storage container,
wherein a vertical distance between the base and the container support is set such that, when the delivery vehicle is positioned in a storage container transfer position below the container support of the temporary station, the weight of the storage container is on the container support when the container carrier is in the lower position and the weight of the storage container is on the container carrier when the container carrier is in the upper position,
wherein the elevating device is a rolling means displacement assembly connected to the first set of rolling means, and
wherein the rolling means displacement assembly is configured to lift and lower the first set of rolling means relative to the second set of rolling means such that only the first set of rolling means traveling in a desired direction is in contact with the base, and such that the container carrier is in the upper position when the first set of rolling means is lowered and in contact with the base and the container carrier is in the lower position when the first set of rolling means is lifted,
an upper two-dimensional rail system arranged above the base, comprising:
a first set of parallel rails arranged in a horizontal plane and extending in a first direction, and
a second set of parallel rails arranged in the horizontal plane and extending in a second direction perpendicular to the first direction,
said first and second sets of rails forming a grid pattern in the horizontal plane comprising a plurality of adjacent grid cells, each grid cell comprising a grid opening,
a plurality of stacks of storage containers arranged in storage columns beneath the upper rail system, wherein each storage column is located vertically below the grid opening;
a container handling vehicle comprising a lifting device for lifting a storage container stacked in the stacks and configured to drive the vehicle along the upper rail system in at least one of the first direction and the second direction, and
a delivery column for transport of the storage container between the upper rail system and the temporary storage station, wherein the temporary storage station is arranged at the base at the lower end of the delivery column.

12. The automated storage and retrieval system according to claim 11, wherein the delivery vehicle is further adapted to transport the storage container between a first location at the position of the temporary storage station and a second location at a robotic port and/or an operator port for handling of product items stored within the storage container, wherein the robotic port and/or the operator port comprises a second temporary storage station.

13. The automated storage and retrieval system comprising:
a storage container handling system comprising:
a base,
a delivery vehicle configured to travel on the base, the delivery vehicle comprising:
a rolling base unit comprising first and second sets of rolling means for guiding the delivery vehicle along the base in a first and second directions respectively;
a container carrier provided on the rolling base unit, the container carrier being configured to removably support a storage container from below; and
an elevating device configured to move the container carrier vertically between an upper and a lower position relative to the base,
a temporary storage station for temporarily storing a storage container to be picked-up or dropped off by the delivery vehicle, the temporary storage station comprising a fixed container support configured to removably support the storage container,
wherein a vertical distance between the base and the container support is set such that, when the delivery vehicle is positioned in a storage container transfer position below the container support of the temporary station, the weight of the storage container is on the container support when the container carrier is in the lower position and the weight of the storage container is on the container carrier when the container carrier is in the upper position,
wherein the elevating device is a rolling means displacement assembly connected to the first set of rolling means, and
wherein the rolling means displacement assembly is configured to lift and lower the first set of rolling means relative to the second set of rolling means such that only the first set of rolling means traveling in a desired direction is in contact with the base, and such that the container carrier is in the upper position when the first set of rolling means is lowered and in contact with the base and the container carrier is in the lower position when the first set of rolling means is lifted,
a plurality of stacks of storage containers arranged in storage columns beneath the rail system, wherein each storage column is located vertically below the grid opening, and
a container handling vehicle comprising a lifting device for lifting a storage container stacked in the stacks and configured to drive the vehicle along the rail system in at least one of the first direction and the second direction, wherein
the temporary storage station is fixed on the two-dimensional rail system.

14. A method of transferring a storage container between a delivery vehicle and a temporary storage station, the delivery vehicle being configured to move on a base comprising an automated storage and retrieval system comprising:
a storage container handling system comprising:
a base,
a delivery vehicle configured to travel on the base, the delivery vehicle comprising:
a rolling base unit comprising first and second sets of rolling means for guiding the delivery vehicle along the base in a first and second directions respectively;
a container carrier provided on the rolling base unit, the container carrier being configured to removably support a storage container from below; and
an elevating device configured to move the container carrier vertically between an upper and a lower position relative to the base,
a temporary storage station for temporarily storing a storage container to be picked-up or dropped off by the delivery vehicle, the temporary storage station comprising a fixed container support configured to removably support the storage container,
wherein a vertical distance between the base and the container support is set such that, when the delivery vehicle is positioned in a storage container transfer position below the container support of the temporary station, the weight of the storage container is on the container support when the container carrier is in the lower position and the weight of the storage container is on the container carrier when the container carrier is in the upper position,
wherein the elevating device is a rolling means displacement assembly connected to the first set of rolling means, and
wherein the rolling means displacement assembly is configured to lift and lower the first set of rolling means relative to the second set of rolling means such that only the first set of rolling means traveling in a desired direction is in contact with the base, and such that the container carrier is in the upper position when the first set of rolling means is lowered and in contact with the base and the container carrier is in the lower position when the first set of rolling means is lifted,
an upper two-dimensional rail system arranged above the base, comprising:
a first set of parallel rails arranged in a horizontal plane and extending in a first direction, and
a second set of parallel rails arranged in the horizontal plane and extending in a second direction perpendicular to the first direction,
said first and second sets of rails forming a grid pattern in the horizontal plane comprising a plurality of adjacent grid cells, each grid cell comprising a grid opening,
a plurality of stacks of storage containers arranged in storage columns beneath the upper rail system, wherein each storage column is located vertically below the grid opening;
a container handling vehicle comprising a lifting device for lifting a storage container stacked in the stacks and configured to drive the vehicle along the upper rail system in at least one of the first direction and the second direction, and
a delivery column for transport of the storage container between the upper rail system and the temporary storage station, wherein the temporary storage station is arranged at the base at the lower end of the delivery column, the method comprising:
a) operating the elevating device, wherein the elevating device comprises the rolling means displacement assembly, such that the container carrier with a storage container supported thereon is in an upper position when the first set of rolling means is lowered and in contact with the base;
b) moving the delivery vehicle to a location on the base where the elevating device is arranged below the container support;
c) transferring the storage container from the container carrier to the container support by operating the elevating device from the upper position to the lower position; and
d) moving the delivery vehicle in opposite direction relative to step a).
